(19) United States
(12) Patent Application Publication
(10) Pub. No.: US 2019/0039198 A1
(43) Pub. Date: Feb. 7, 2019

(54) MACHINING SWARF DETECTION APPARATUS AND MACHINE TOOL

(71) Applicant: OKUMA Corporation, Niwa-gun Aichi (JP)

(72) Inventor: Hiroyuki SUGIURA, Niwa-gun Aichi (JP)

(21) Appl. No.: 16/053,147

(22) Filed: Aug. 2, 2018

(30) Foreign Application Priority Data
Aug. 4, 2017 (JP) 2017-151966

(51) Int. Cl. B23Q 11/00; G06T 7/00

(52) U.S. Cl. CPC B23Q 11/0075; G06T 7/001

(57) ABSTRACT

A machining swarf detection apparatus that detects presence or absence of machining swarf in a machining chamber of a machine tool includes an illumination unit that illuminates line laser light onto a detection area in the machining chamber, an imaging unit that images the detection area and acquires an image as an inspection image, and an image processor (controller) that detects the presence or absence of the machining swarf based on an image of the line laser light imaged in the inspection image.

### CROSS REFERENCE TO RELATED APPLICATION

The present application claims priority under 35 U.S.C. § 119 to Japanese Patent Application No. 2017-151966 filed on Aug. 4, 2017, the entire contents of which are incorporated herein by reference.

### TECHNICAL FIELD

The present disclosure relates to a machining swarf detection apparatus which detects presence or absence of machining swarf in a machining chamber of a machine tool, and to a machine tool having the machining swarf detection apparatus.

### BACKGROUND

In a machining chamber of a machine tool, machining swarf such as machining swarf (so-called cutting powder, swarf) produced during the machining or the like may accumulate. When a large amount of machining swarf is cumulated, a movable part of the machining tool may be caught in the machining swarf, and problems may arise in that smooth driving of the movable part is obstructed, or the like. In consideration of this, in the related art, a cleaning mechanism which cleans the inside of the machining chamber by discharging machining swarf to the outside of the machining chamber is provided in the machining chamber. The cleaning mechanism includes, for example, a spray nozzle that sprays a fluid and discharges the machining swarf to the outside of the machining chamber.

However, when the location of accumulation of machining swarf is not known, the spray nozzle or the like cannot be placed at an appropriate position, and the machining chamber cannot be sufficiently cleaned. Thus, some have proposed to specify the location of accumulation of machining swarf based on image data obtained by imaging the inside of the machining chamber.

For example, JP 2016-120589 A discloses a technique in which a visual sensor is attached to a robot provided in the machining chamber, the inside of the machine of the machine tool is imaged by the sensor, and the image data are compared with a template image obtained by imaging the machining chamber in a state where there is no accumulation of the cutting powder, to thereby detect the presence or absence and the location of the cutting powder. According to the technique of JP 2016-120589 A, the cleaning position by the cleaning mechanism can be changed according to the detected position of the cutting powder, and thus, the inside of the machining chamber can be more reliably cleaned.

In the technique of the related art such as that described in JP 2016-120589 A, the inside of the machining chamber is simply imaged. Because of this, when a color tone of the machining swarf and a color tone of a surface in the machining chamber are similar to each other, it has been difficult to clearly distinguish between the machining swarf and the surface in the machining chamber, which resulted in degradation of detection precision of the machining swarf. In particular, when the machining swarf is machining swarf (cutting powder, swarf) when a workpiece made of a metal is machined and a bottom surface of the machining chamber is covered by a telescopic cover made of a metal, the color tone of the telescopic cover (metal) and the color tone of the machining swarf (metal) tend to be similar, and it has been difficult to clearly distinguish the telescopic cover and the machining swarf from each other. Moreover, even when the color tone differs between the surface in the machining chamber and the machining swarf, depending on various conditions such as a partial stain in the machining chamber, a manner of casting of the illumination, a shape of the machining swarf, or the like, it may become impossible to clearly distinguish between the surface in the machining chamber and the machining swarf, which similarly results in the degradation of the detection precision of the machining swarf.

An advantage of the present disclosure lies in provision of a machining swarf detection apparatus and a machine tool, which can improve the detection precision of machining swarf in the machining chamber.

### SUMMARY

According to one aspect of the present disclosure, there is provided a machining swarf detection apparatus that detects presence or absence of machining swarf in a machining chamber of a machine tool, the machining swarf detection apparatus comprising: an illumination unit that illuminates line laser light onto a detection area in the machining chamber; an imaging unit that images the detection area and acquires an image as an inspection image; and an image processor that detects presence or absence of the machining swarf based on an image of the line laser light imaged in the inspection image.

According to another aspect of the present disclosure, the image processor may detect the presence or the absence of machining swarf based on at least one of a length, a number, a spacing, and a direction of one or more line segments forming the image of the line laser light.

According to another aspect of the present disclosure, the image processor may detect an existing location of the machining swarf based on a comparison between a reference image showing an image of the line laser light acquired when there is no machining swarf in the detection area, and the inspection image.

According to another aspect of the present disclosure, the line laser light may have a wavelength peak different from a wavelength peak of illumination light for illuminating the inside of the machining chamber.

According to another aspect of the present disclosure, at least one of the illumination unit and the imaging unit may be attached to a movable element provided in the machining chamber. According to another aspect of the present disclosure, the movable element may be at least one of an in-machine robot, a tool post, a tool spindle, a workpiece table, and a tailstock, placed in the machining chamber.

According to another aspect of the present disclosure, there is provided a machine tool comprising the machining swarf detection apparatus described above.

According to another aspect of the present disclosure, the machine tool may further comprise: a control device that controls driving of the machine tool; and a cleaning mechanism that cleans the inside of the machining chamber by removing the machining swarf, and the control device may determine a location of cleaning by the cleaning mechanism according to a result of detection by the machining swarf detection apparatus. According to another aspect of the present disclosure, the control device may cause execution of the detection of the machining swarf by the machining swarf detection apparatus and the cleaning by the cleaning mechanism during a period in which machining of a workpiece is not executed.

Because the machining swarf detection apparatus according to the present disclosure can detect the presence or absence of the machining swarf based on an image of line laser light imaged in an inspection image, the presence or absence of the machining swarf can be more accurately detected even when the color tone is similar between a surface in the machining chamber and the machining swarf.

### BRIEF DESCRIPTION OF DRAWINGS

Embodiment(s) of the present disclosure will be described by reference to the following figures, wherein:

FIG. 1 is a diagram showing a structure of a machining swarf detection apparatus;

FIG. 2 is a diagram showing an example of an optical member provided on an illumination unit;

FIG. 3A is a diagram showing an example of an inspection image;

FIG. 3B is a diagram showing another example of the inspection image;

FIG. 3C is a diagram showing another example of the inspection image;

FIG. 3D is a diagram showing a further example of the inspection image;

FIG. 4 is a flowchart showing a flow of a machining swarf detection process;

FIG. 5 is a diagram showing an example of an inspection image;

FIG. 6 is a diagram showing an example of a binarized inspection image;

FIG. 7 is a diagram showing an example of a reference image;

FIG. 8 is a diagram showing a machine tool into which a machining swarf detection apparatus is incorporated; and

FIG. 9 is a flowchart showing a flow of a cleaning process.

### DESCRIPTION OF EMBODIMENTS

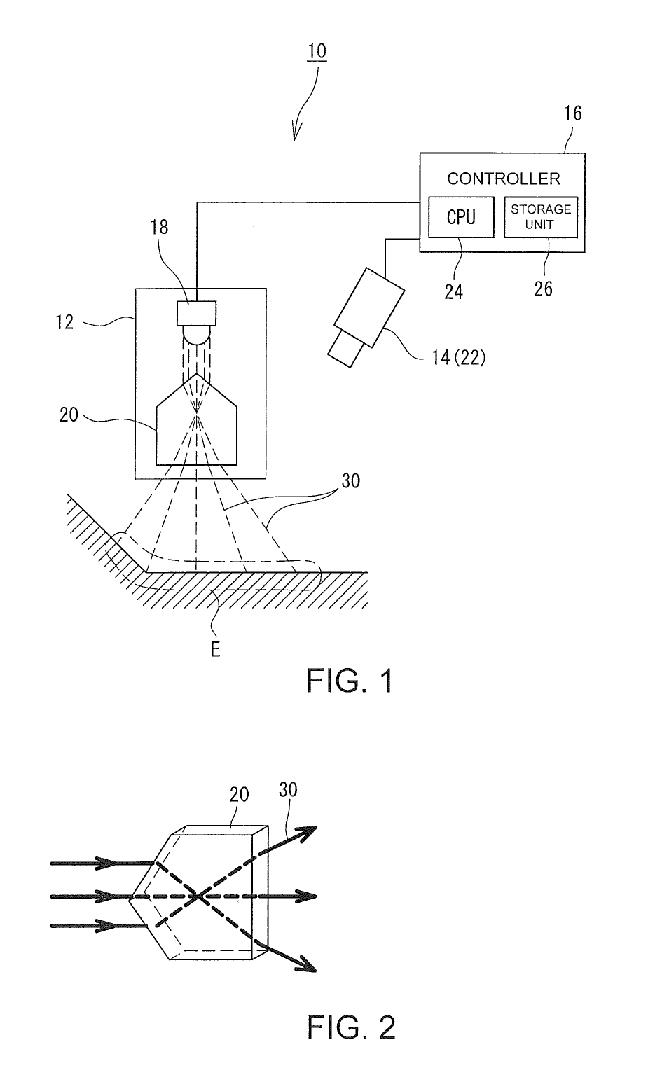

A structure of a machining swarf detection apparatus 10 will now be described with reference to the drawings. FIG. 1 is a diagram schematically showing a structure of a machining swarf detection apparatus 10 which detects machining swarf. The machining swarf detection apparatus 10 detects, for example, presence or absence of machining swarf in a machining chamber of a machine tool. The machining swarf detection apparatus 10 may be incorporated into the machine tool in advance or may be a separate apparatus from the machine tool. No particular limitation is imposed on the machine tool on which the machining swarf detection apparatus 10 is equipped, so long as machining swarf is produced in machining. In the following description, there will be exemplified a machining swarf detection apparatus 10 which is equipped in a machine tool which executes lathe-turning or cut-machining and which detects cutting dust or swarf as the machining swarf.

The machining swarf detection apparatus 10 comprises an illumination unit 12, an imaging unit 14, and a controller 16. The illumination unit 12 illuminates line laser light 30 which is wide in one direction onto a detection area E which is an arbitrary area in the machining chamber. Various structures may be considered for the illumination unit 12, and, for example, the illumination unit 12 may comprise a light source 18, and an optical member 20 which expands laser light from the light source 18 in one direction. No particular limitation is imposed on the light source 18 so long as the light source 18 can illuminate laser light of a sufficient intensity, and, for example, a laser diode, a light emitting diode (LED), or the like, may be employed as the light source 18. In addition, the number of the light source 18 is not limited to one, and may alternatively be a plurality. The optical member 20 expands the laser light illumination from the light source 18 in one direction, and, for example, as shown in FIG. 2, a lens or the like having an approximate home-plate shape may be employed.

The line laser light 30 illuminated from the illumination unit 12 is desirably light which can clearly distinguish between a surface of a machining chamber and the machining swarf. Therefore, the line laser light 30 desirably has a wavelength peak different from a wavelength peak of illumination light of the machining chamber. For example, when the illumination light of the machining chamber is a white LED in which a yellow fluorescent material is caused to emit light by a blue LED, the wavelength peaks of the illumination light appear around 460 nm and 560 nm. In this case, the line laser light 30 desirably has a wavelength peak outside of the range of 460 nm˜560 nm. In addition, the line laser light 30 is not limited to visible light, and may alternatively be ultraviolet ray or infrared ray.

The imaging unit 14 comprises, for example, a camera 22, and acquires an illumination surface of the line laser light 30 as an inspection image 32. Here, the camera 22 may be a still camera which acquires a static image, or a video camera which acquires a video image. When the line laser light 30 is the ultraviolet ray or the infrared ray, an ultraviolet camera or an infrared camera is desirably used for the camera 22, which has sensitivity to imaging of the ultraviolet ray or the infrared ray. In any case, the image acquired by the camera 22 is sent to the controller 16 as the inspection image 32.

The illumination unit 12 and the imaging unit 14 are placed in the machining chamber of the machine tool. No particular limitation is imposed on the placement location of the illumination unit 12 and the imaging unit 14, but the units are desirably attached to a movable element which moves in the machining chamber and are movable with the movable element. Examples of the movable element include a tool spindle and a workpiece table in a milling machine, a tool post and a tailstock of a lathe, and an in-machine robot provided in the machine tool. The illumination unit 12 and the imaging unit 14 may be attached to the same movable element or to different movable elements. In addition, the illumination unit 12 and the imaging unit 14 may be separated from the placement location as necessary, and may be taken out from the machining chamber.

The controller 16 controls driving of the illumination unit 12 and the imaging unit 14, and also functions as an image processor which judges the presence or absence of the machining swarf based on the obtained inspection image 32. The controller 16 comprises at least a CPU 24 which executes various calculations, and a storage device 26 which stores various information. The controller 16 may be, for example, a part of a numerical control apparatus which controls driving of the machine tool, or may be provided separately from the machine tool. Further, the controller 16 can communicate with the illumination unit 12 and the imaging unit 14 via a wire or wirelessly, and can exchange various signals and data with these units. Therefore, the controller 16 may be an information terminal, such as a part of a personal computer, a smartphone, or the like, provided at a remote location distant from the machine tool (and consequently, the illumination unit 12 and the imaging unit 14).

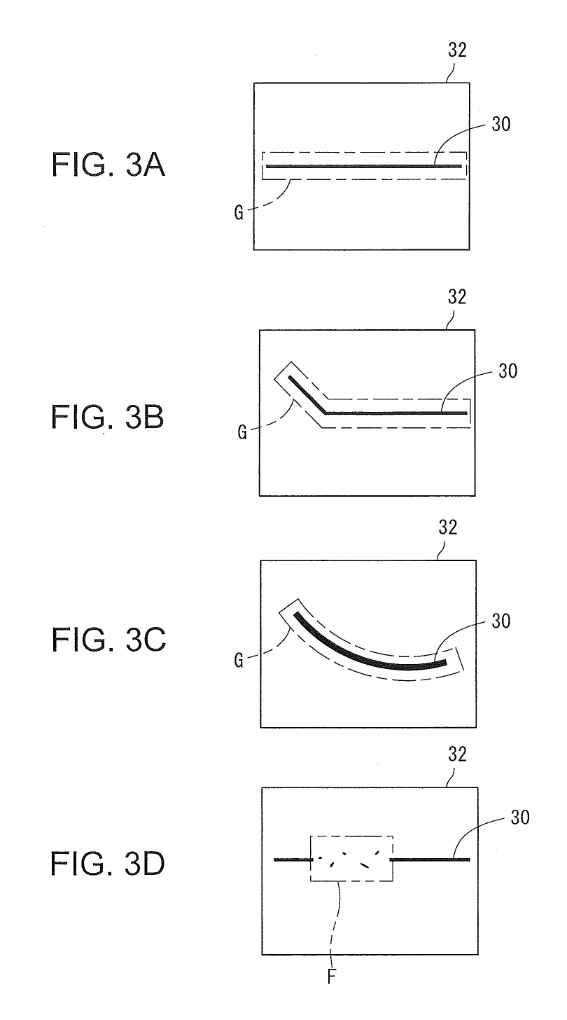

The controller 16 detects presence or absence of the machining swarf based on the inspection image 32 acquired by the imaging unit 14. A principle of the detection will now be described. FIGS. 3A˜3D are diagrams showing examples of the inspection image 32. In the inspection image 32, a structural surface of the machining chamber, constructions present in the machining chamber, the machining swarf, and the like are also imaged, but for the purpose of explanation, FIGS. 3A˜3D only show the image of the line laser light 30.

In general, a surface forming the machining chamber is formed by a combination of flat surfaces or simple curved surfaces. In other words, a side surface of the machining chamber or the like is basically a flat surface. Moreover, a bottom surface of the machining chamber is covered by a telescopic cover for allowing sliding of the movable part (such as the tool post). The telescopic cover is generally formed by combining flat plates in a bellows form, and the bottom surface of the machining chamber covered by the telescopic cover may be assumed to be an approximate flat surface. In addition, in the machining chamber, a number of constructions, such as a workpiece table, a tool post, a tailstock, or the like, are placed. These constructions are also formed basically of flat surfaces and/or simple curved surfaces.

When the line laser light 30 is illuminated onto such a surface in which the flat surfaces and/or the simple curved surfaces are combined, the image of the line laser light 30 in the inspection image would also be a combination of simple straight lines and/or curved lines. Specifically, when the illumination surface of the line laser light 30 is a simple flat surface, the image of the line laser light 30 imaged in the inspection image 32 is a straight line, as shown in FIG. 3A. When the illumination surface of the line laser light 30 is bent in the partway as shown in FIG. 1, the image of the line laser light 30 imaged in the inspection image 32 is a bent line which is bent partway, as shown in FIG. 3B. When the illumination surface of the line laser light 30 is a gradually curved surface, the image of the line laser light 30 imaged in the inspection image 32 is a gradually curved line, as shown in FIG. 3C. In any case, when the illumination surface of the line laser light 30 is a surface in which the flat surfaces and/or the simple curved surfaces are combined, the image of the line laser light 30 imaged in the inspection image 32 is substantially one line, with no discontinuation in the middle.

On the other hand, the machining swarf such as cutting dust and swarf produced in the process of the cutting machining or lathe-turning machining has a spiral shape or a small chip shape in many cases, with the shape changing randomly. When such machining swarf exists at an illumination location of the line laser light 30, the line laser light 30 would diffusely reflect around the machining swarf, and is observed as intermittent light. Specifically, as shown in FIG. 3D, when the machining swarf is accumulated in a region F, the image of the line laser light 30 imaged in the inspection image 32 would be a line which is discontinuous at the accumulation position of the machining swarf (region F). In the accumulation position of the machining swarf (region F), the image of the line laser light 30 is imaged as a plurality of short line segments extending in random directions.

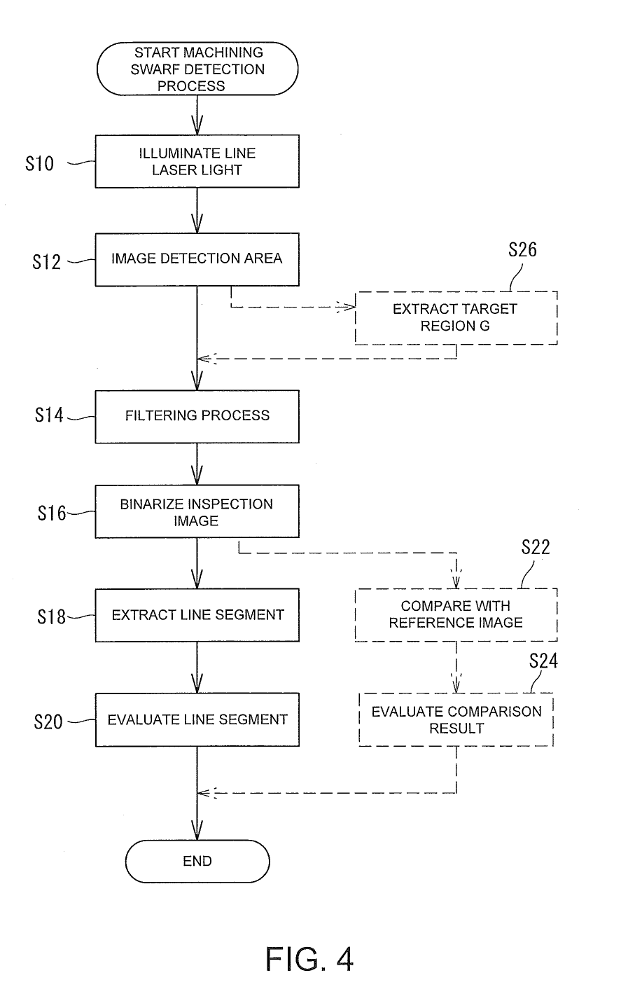

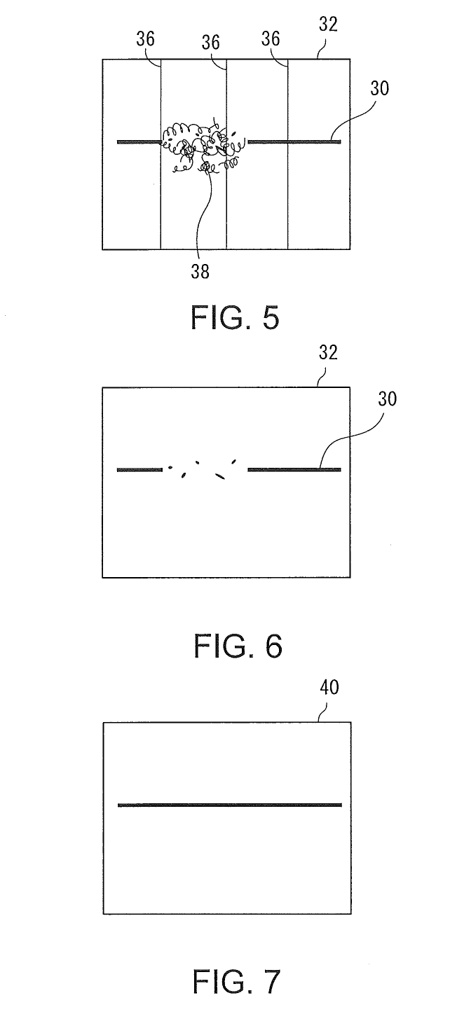

The controller 16 takes advantage of such a difference in the shape of the image of the line laser light 30 depending on the presence or absence of the machining swarf, to detect the presence or absence of the machining swarf. FIG. 4 is a flowchart showing a flow of a detection process of the machining swarf. When the machining swarf is to be detected, the controller 16 drives the illumination unit 12, to illuminate the line laser light 30 onto an arbitrary detection area E in the machining chamber (S10). The controller 16 also drives the imaging unit 14, to image an illumination location (detection area E) of the line laser light 30, and acquires the inspection image 32 (S12). FIG. 5 is a diagram showing an example of the obtained inspection image 32. In the example of FIG. 5, in the inspection image 32, there are imaged an edge 36 of a plate member forming the telescopic cover covering the bottom surface of the machining chamber, machining swarf 38 present on the telescopic cover, and the line laser light 30 illuminated onto the telescopic cover.

When the inspection image 32 is obtained, the controller 16 extracts only the image of the line laser light 30 from the inspection image 32 (S14˜S16). Specifically, the controller 16 binarizes the inspection image 32, to separate the image of the line laser light 30 and other images (S16). Prior to the binarization process, various filtering processes may be applied to the inspection image 32, to facilitate separation of the image of the line laser light 30 and the other images (S14). As the filtering process, there may be considered for example, a process to emphasize a particular color value range or a process to remove a particular color value range. In addition to or in place of the filtering process on the image data, a filter that particularly transmits or blocks light of a particular wavelength may be provided on the camera 22 of the imaging unit 14. In any case, the controller 16 separates the image of the line laser light 30 and the other images by the binarization process. FIG. 6 is a diagram showing an example of the binarized inspection image 32.

Next, the controller 16 extracts line segments from the binarized inspection image 32 (S18). For the extraction of the line segment, there may be employed known digital image processing techniques such as, for example, an edge extraction technique and a Hough transform technique.

When the line segments are extracted, the controller 16 evaluates the extracted line segments (S20). Various methods may be considered as the method of evaluation, and, for example, the controller 16 judges the presence or absence of the machining swarf or the position of the machining swarf based on at least one of a length of the extracted line segment (image of the laser line light), a number of the line segments, a spacing between the line segments, and a direction of the line segments.

For example, the controller 16 may judge that there is machining swarf when there is a line segment of a length shorter than or equal to a predefined threshold, and may detect the position where the line segment of a length shorter than or equal to the predefined threshold as the position where the machining swarf exists. This is because, as described before, at a position where there is the machining swarf, the image of the line laser light 30 is imaged as a plurality of short line segments which extend in random directions. In this process, in order to avoid the influences of noise, the controller 16 may calculate the number or a sum of the lengths of the line segments having a length shorter than or equal to the predefined threshold, and may judge that the machining swarf is present only when the number or the sum is greater than or equal to a certain value. As another configuration, the controller 16 may judge that the machining swarf is present when the spacing between the line segments is greater than or equal to a certain value. As yet another configuration, the controller 16 may judge that the machining swarf is present when the directions of the line segments are randomly distributed. It is sufficient that the controller 16 at least detects the presence or absence of the machining swarf, and the detection of the position (coordinate position in the inspection image 32) where the machining swarf exists may be omitted.

In the above, an example has been described in which the presence or absence of the machining swarf is detected by referring only to the inspection image 32, but in some cases, the presence or absence of the machining swarf may be detected by referring to other information. For example, the controller 16 may store as a reference image 40 in advance a binarized image which would be obtained when no machining swarf is present in the detection area E, and may detect the presence or absence of the machining swarf by referring to the reference image 40. FIG. 7 is a diagram showing an example of the reference image 40.

When the reference image 40 is stored, after the controller 16 binarizes the inspection image 32, the controller 16 compares the binarized inspection image 32 and the reference image 40 (S22). The controller 16 then evaluates the comparison result (S24). A concrete example of the comparison of the images (S22) and the evaluation of the comparison result (S24) will now be described. In order to compare the reference image 40 and the inspection image 32, the controller 16 uses a method such as pattern matching, to match the coordinate positions of the inspection image 32 and the reference image 40 so that the position of the image of the line laser light 30 matches. Then, the controller 16 divides the inspection image 32 and the reference image 40 into a plurality of evaluation blocks, and calculates, for each evaluation block, an evaluation value (for example, an accumulated value of a sum of squares of a difference of pixel values) showing a difference between the reference image 40 and the inspection image 32. The controller 16 may then judge that the machining swarf is accumulated in the block if there is an evaluation block where the obtained evaluation value (comparison result) is greater than or equal to a predefined reference value. With such a structure, a complicated calculation such as the Hough transform can be omitted, and the load of calculation imposed on the controller 16 can be reduced.

Further, in the above description, the presence or absence of the machining swarf is detected using the entirety of the inspection image 32, but alternatively, the machining swarf may be detected using only a part of the inspection image 32. For example, as shown in FIGS. 3A˜3C, of the inspection image 32, a region G in which the image of the line laser light 30 is imaged is approximately fixed. Therefore, the controller 16 may store in advance the region where the image of the line laser light 30 is imaged as a target region G, and may extract only the target region G from the inspection image 32 prior to the filtering process (S26). The subsequent processes (S14˜S24) may be executed on the image data corresponding to the target region G. With such a structure, an amount of calculation of the controller 16 can be significantly reduced. The target region G may be automatically specified by the controller 16 based on the inspection image 32 acquired before the machining is started; that is, before the machining swarf is produced. As another configuration, the target region G may be instructed by the user referring to the inspection image 32 acquired before the machining is started; that is, before the machining swarf is produced.

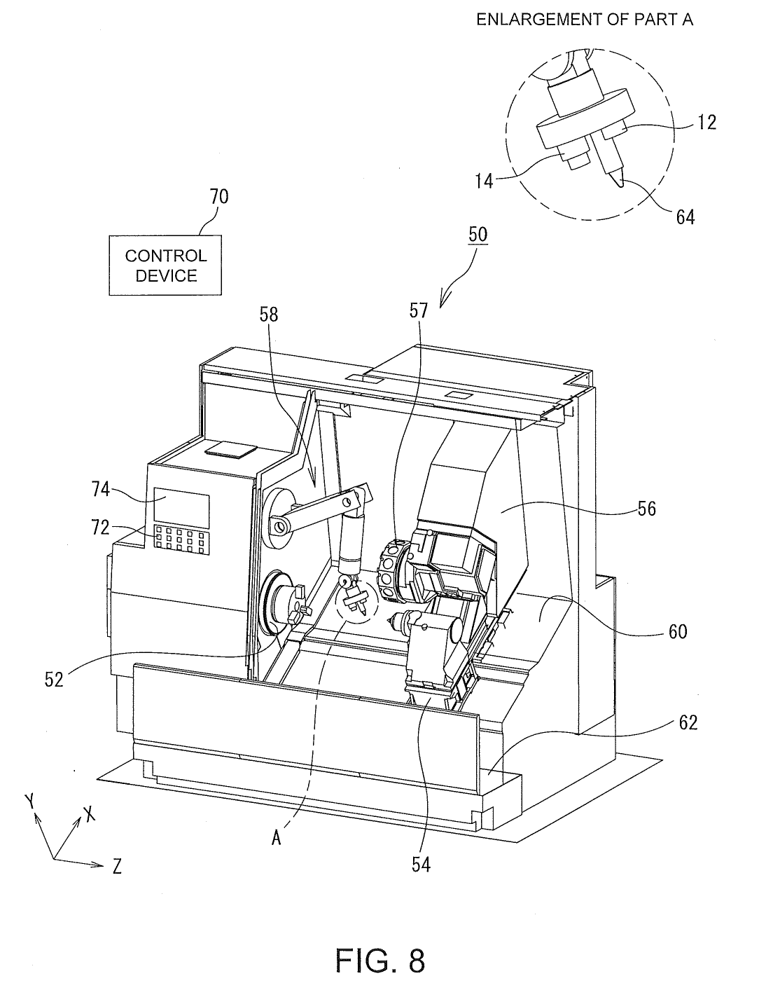

Next, a machine tool 50 into which the above-described machining swarf detection apparatus 10 is incorporated will be described with reference to FIG. 8. In an actual machine tool 50, the machining chamber is covered by a cover having a door, but in FIG. 8, for the purpose of ease of view, the cover is not shown. In addition, while the bottom surface of the machining chamber is covered by the telescopic cover, in FIG. 8, the telescopic cover is also not shown. Moreover, in the following description, a direction of a rotational axis of a workpiece spindle 52 is referred to as a Z-axis, a movement direction of a tool post 56 orthogonal to the Z-axis is referred to as an X-axis, and a direction orthogonal to the X-axis and the Z-axis is referred to as a Y-axis.

The machine tool 50 is a lathe which machines a workpiece by causing a tool held by the tool post 56 to contact a self-rotating workpiece. The machine tool 50 is NC-controlled, and is a lathe which is called a turning center which holds a plurality of tools. The machine tool 50 comprises the workpiece spindle 52 which holds one end of the workpiece in a manner to allow self rotation, the tool post 56 which holds the tool, a tailstock 54 which supports the other end of the workpiece, and an in-machine robot 58. The tailstock 54 is placed to oppose the workpiece spindle 52 in the Z-axis direction, and supports the other end of the workpiece which is held by the workpiece spindle 52. The tailstock 54 is movable in the Z-axis direction so that the tailstock 54 can move toward or away from the workpiece. Therefore, the tailstock 54 may be considered one of movable elements which can move in the machining chamber.

The tool post 56 holds a tool, such as a tool called a bite. The tool post 56 is movable in the Z-axis direction. In addition, the tool post 56 is mounted on a guiderail which extends in the X-axis direction, and can move back and forth in the X-axis direction. Therefore, the tool post 56 also may be considered one of the movable elements which can move in the machining chamber. At a tip of the tool post 56, a turret 57 which can hold a plurality of the tools is provided. The turret 57 is rotatable about an axis extending in the Z-axis direction. With a rotation of the turret 57, the tool to be used for the machining of the workpiece can be suitably changed.

No particular limitation is imposed on the form and placement position of the in-machine robot 58 so long as the in-machine robot 58 can move independently from the tool post 56 and the tailstock 54. In the illustrated example, the in-machine robot 58 is an articulated robot having a plurality of arms connected via joints, and is attached near the workpiece spindle 52. Here, the in-machine robot 58 may also be considered one of the movable elements which can move in the machining chamber, similar to the tool post 56 and the tailstock 54.

The illumination unit 12 and the imaging unit 14 forming the machining swarf detection apparatus 10 are attached to the movable element which can move in the machining chamber, and can move along with the movable element. No particular limitation is imposed on the movable element on which the illumination unit 12 and the imaging unit 14 are attached. The illumination unit 12 and the imaging unit 14 may be attached to the same movable element or movable elements different from each other. As will be described below, when the machining swarf detection process is to be executed at a timing of automatic tool exchange, automatic workpiece exchange, or the like, the illumination unit 12 and the imaging unit 14 are desirably attached to a movable element different from the movable element which holds the tool (such as the tool post 56 in the lathe and a tool spindle in a milling machine), and the movable element which holds the workpiece (such as the workpiece spindle 52 in the lathe and the workpiece table in the milling machine). In the exemplified configuration of FIG. 8, the illumination unit 12 and the imaging unit 14 are both attached on the tip of the in-machine robot 58, and move with the tip of the in-machine robot 58.

On the tip of the in-machine robot 58, a cleaning mechanism 64 is further provided. The cleaning mechanism 64 is a mechanism which moves the machining swarf accumulated in the machining chamber to a chip conveyer side to be described later, and removes the machining swarf, and includes, for example, a spray nozzle for spraying fluid, a brush for sweeping the machining swarf, or the like. In the exemplified configuration of FIG. 8, on the tip of the in-machine robot 58, a spray nozzle is provided as the cleaning mechanism 64. The fluid sprayed by the spray nozzle may be liquid such as cutting oil, or may be gas such as compressed air.

On the bottom surface of the machining chamber, a sliding member (for example, a guiderail or the like) for moving the tailstock 54 and the tool post 56 is provided. When the machining swarf such as the swarf is caught in the sliding member, stable movement of the tailstock 54, the tool post 56, or the like is obstructed. Therefore, in order to allow the movement of the tailstock 54 and the tool post 56 while preventing intrusion of the machining swarf into the sliding member, the bottom surface of the machining chamber is covered by a telescopic cover (not shown).

At a front end of the machining chamber, a chip conveyer 62 for collecting and discharging the machining swarf is provided. The bottom surface of the machining chamber is inclined, and lowered toward the chip conveyer 62. Because of this, much of the machining swarf naturally moves to the chip conveyer 62 by the force of gravity. Depending on the location, however, the machining swarf may be caught in other members and may be accumulated there. A control device 70 to be described later uses the cleaning mechanism 64 as necessary, to discharge the accumulated machining swarf to the chip conveyer 62.

The control device 70 controls driving of various parts of the machine tool 50 according to a command from an operator. The control device 70 comprises, for example, a CPU which executes various calculations, and a memory which stores various control programs and control parameters. The control device 70 also has a communication function, and can exchange various data such as, for example, NC program data, with other devices. The control device 70 may include, for example, a numerical control apparatus which continuously calculates the positions of the tool and the workpiece. The control device 70 may be a single device, or may be formed by combining a plurality of calculation devices.

The control device 70 also functions as the controller 16 of the machining swarf detection apparatus 10. The control device 70 causes the illumination unit 12 and the imaging unit 14 to execute the illumination of the line laser light 30 and the imaging of the illumination surface as necessary. The control device 70 additionally executes the cleaning process to clean the inside of the machining chamber as necessary. Details of the cleaning process will be described later. In the present embodiment, the control device 70 of the machine tool 50 functions as the controller 16 of the machining swarf detection apparatus 10. However, as described previously, it is not necessary that the controller 16 of the machining swarf detection apparatus 10 is incorporated in the machine tool 50. Therefore, the controller 16 of the machining swarf detection apparatus 10 may be an information terminal provided at a remote location distanced from the machine tool 50 and which can communicate with the control device 70 of the machine tool 50.

The machine tool 50 further comprises an input device 72 which receives a command from a user, and an output device 74 which presents various types of information to the user. The input device 72 includes, for example, a keyboard, a touch panel, a microphone, or the like. The output device 74 includes, for example, a display, a speaker, or the like. On the display, information showing contents of the process of the machining swarf detection may be displayed. The information showing the process contents include, for example, the inspection image acquired by the imaging unit 14, the binarized image produced during the image processing, and the detection result of the machining swarf (an image showing presence or absence of the machining swarf, or an accumulation area of the machining swarf).

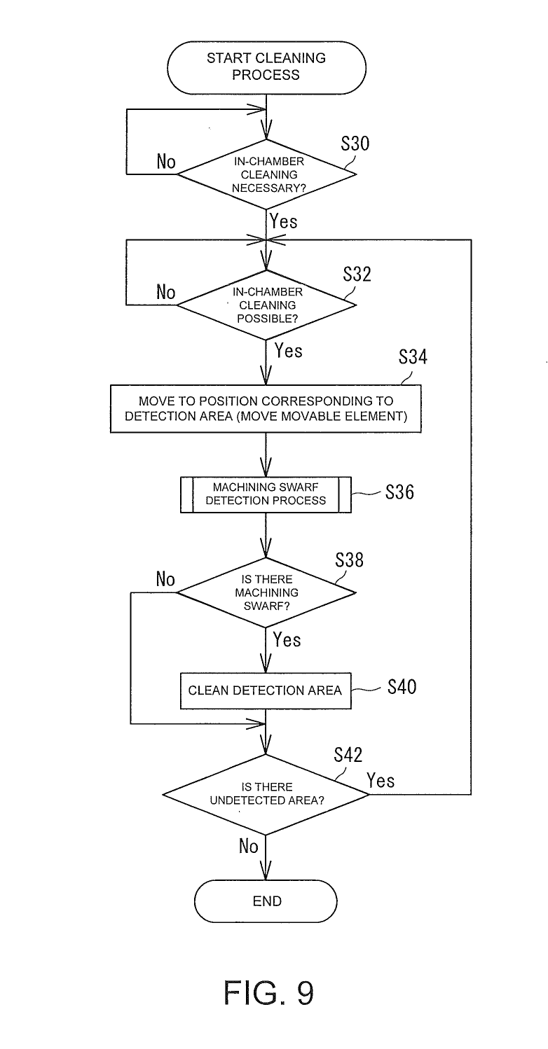

Next, the cleaning process for cleaning the inside of the machining chamber will be described with reference to FIG. 9. FIG. 9 is a flowchart showing a flow of the cleaning process. The flowchart of FIG. 9 is repeatedly executed at a predetermined interval after the power supply of the machine tool 50 is switched ON.

As shown in FIG. 9, the control device 70 periodically checks if cleaning of the inside of the machining chamber is necessary (S30). Here, a standard of the judgment for necessity of cleaning may be suitably changed according to characteristics of the machine tool 50, preferences of the user, and contents of the machining program to be executed. For example, the control device 70 may judge the necessity of the cleaning based on an elapsed time from a previous cleaning process, an amount of machining swarf produced after the previous cleaning process, and presence or absence of a command from the user.

Specifically, for example, the controller 16 may judge that the machining swarf which should be cleaned is piled up and the cleaning is necessary when a sufficient time has elapsed from execution of the previous cleaning operation. In addition, the amount of machining swarf produced can be estimated to a certain degree by interpreting the machining program. Therefore, the controller 16 may judge that the cleaning is necessary when the controller 16 judges based on the machining program that the amount of machining swarf newly produced from the execution of the previous cleaning operation becomes greater than or equal to a certain value. Further, the control device 70 may judge that the cleaning is necessary upon receiving a command of execution of cleaning from the user.

When the control device 70 judges that the cleaning is not necessary, the control device 70 continues to wait until the cleaning becomes necessary. On the other hand, when the control device 70 judges that the cleaning is necessary, the control device 70 judges whether or not execution of the cleaning process is possible (S32). A standard of judgment of possibility of cleaning may be suitably changed according to the characteristics of the machine tool 50, the preferences of the user, and the contents of the machining program to be executed. For example, the control device 70 may judge the possibility of cleaning based on a progress situation of the machining. Specifically, for example, the control device 70 judges that the cleaning is not possible during lathe-turning of the workpiece, and judges that the cleaning is possible during a period in which the lathe-turning of the workpiece is temporarily or completely stopped. The timing of temporarily stopping the lathe-turning includes, for example, a timing when the tool is automatically exchanged and a timing when the workpiece is exchanged.

When the control device 70 judges that the cleaning is not possible, the control device 70 waits until the cleaning becomes possible. On the other hand, when the control device 70 judges that the cleaning of the inside of the machining chamber is possible, the control device 70 drives the in-machine robot 58 which is the movable element, to move the illumination unit 12 and the imaging unit 14 to a position corresponding to the detection area E (S34). As already described, the detection area E is an area illuminated by the line laser light 30, and is an area in which the detection of the presence or absence of the machining swarf is executed. The detection area E may be defined in advance for each machine tool 50. Specifically, a point where the accumulation of the machining swarf is easily caused is fixed to a certain degree. Therefore, the control device 70 may store, as the detection area E, an area around the point where the accumulation of the machining swarf tends to occur. As another configuration, the control device 70 may specify the point where the accumulation of the machining swarf tends to occur, based on the contents of the machining program which is executed immediately before, and specify an area around the point as the detection area E for each machining program. As another configuration, the detection area E may be designated by the user. As yet another configuration, the control device 70 may scan the movable element (the illumination unit 12 and the imaging unit 14) in a predetermined direction, to allow detection of the presence or absence of the machining swarf over the entire bottom surface of the machining chamber.

When the units 12 and 14 are moved to positions corresponding to the predetermined detection area E, the control device 70 executes the machining swarf detection process (S36). The flow of the detection process is already described and shown in FIG. 4. That is, the control device 70 uses the illumination unit 12 to illuminate the line laser light 30 onto the detection area E (S10), and images the detection area E with the imaging unit 14 (S12). The control device 70 applies the filtering process (S14) and the binarization process (S16) on the inspection image 32 obtained by the imaging unit 14, to extract the image of the line laser light 30. The control device 70 then judges at least the presence or absence of the machining swarf based on the extracted image of the line laser light 30.

When the control device 70 judges that the machining swarf is present in the detection area E as a result of the machining swarf detection process, the control device 70 executes the cleaning of the detection area E using the cleaning mechanism 64 (S40). Specifically, fluid is sprayed onto the detection area E, to discharge the machining swarf accumulated in the detection area E to the chip conveyer 62 and to clean the area. In the present embodiment, the cleaning mechanism 64 is attached to the same movable element (the in-machine robot 58 in the present embodiment) as that for the illumination unit 12 or the imaging unit 14. Because of this, the cleaning mechanism 64 is always positioned near the illumination unit 12 and the imaging unit 14, and, consequently, near the detection area E. Because of this, a dedicated operation for moving the cleaning mechanism 64 to the cleaning location (detection area E) becomes unnecessary, and the process can be simplified.

When the cleaning of the detection area E is completed, the process proceeds to step S42. In addition, when the control device 70 judges that no machining swarf is present in the detection area E in step S38, the process proceeds to step S42 without executing the cleaning process (S30). In step S42, it is judged whether or not there is an undetected detection area E of the plurality of the detection areas E which are set. When it is judged as a result that there is an undetected detection area E, the process returns to step S32, and the detection of presence or absence of the machining swarf and the cleaning are executed for the next detection area E. On the other hand, when it is judged as a result that there is no undetected detection area E, the cleaning process is completed.

As is clear from the above description, according to the machine tool 50, the presence or absence of the machining swarf is suitably detected, and cleaning is automatically executed when the machining swarf is present. As a result, it becomes possible to effectively prevent accumulation of a large amount of the machining swarf and catching of the machining swarf in the telescopic cover and the sliding unit.

The structure described above is an exemplary structure, and the structures may be suitably changed so long as presence or absence of the machining swarf is detected based on the image of the line laser light 30. For example, in the flowchart of FIG. 8, the cleaning of one detection area E is executed after the machining swarf detection process is executed for the detection area E. Alternatively, a configuration may be employed in which the machining swarf detection process is successively executed for a plurality of the detection areas E, and the cleaning is successively executed for one or more detection areas E which are judged as having the machining swarf.

In addition, in the exemplified configuration of FIG. 8, the cleaning is executed for the entire detection area E judged as having the machining swarf. Alternatively, the position where the machining swarf is accumulated may be specified in more detail, and the cleaning may be executed for the specified position. For example, in the machining swarf detection process, a position on the inspection image 32 (coordinate position) where the machining swarf is accumulated may be specified, and the control device 70 may specify an actual position of the machining swarf based on the coordinate position and the actual position of the movable element (actual position of the imaging unit 14). The control device 70 may then execute the cleaning process for the specified actual position.

In the above description, the machine tool 50 that executes lathe-turning machining is exemplified. Alternatively, the machine tool 50 to which the machining swarf detection apparatus 10 is equipped may be another machine such as, for example, a milling machine which executes cut-machining, a multi-tasking machine which executes cut-machining and lathe-turning machining, and a press machine which executes press machining.

1. A machining swarf detection apparatus that detects presence or absence of machining swarf in a machining chamber of a machine tool, the machining swarf detection apparatus comprising:
an illumination unit that illuminates line laser light onto a detection area in the machining chamber;
an imaging unit that images the detection area and acquires an image as an inspection image; and
an image processor that detects the presence or absence of the machining swarf based on an image of the line laser light imaged in the inspection image.

2. The machining swarf detection apparatus according to claim 1, wherein
the image processor detects the presence or absence of the machining swarf based on at least one of a length, a number, a spacing, and a direction of one or more line segments forming the image of the line laser light.

3. The machining swarf detection apparatus according to claim 1, wherein
the image processor detects an existing location of the machining swarf based on a comparison between a reference image showing an image of the line laser light acquired when no machining swarf is present in the detection area, and the inspection image.

4. The machining swarf detection apparatus according to claim 1, wherein
the line laser light has a wavelength peak different from a wavelength peak of illumination light for illuminating the inside of the machining chamber.

5. The machining swarf detection apparatus according to claim 1, wherein
at least one of the illumination unit and the imaging unit is attached to a movable element provided in the machining chamber.

6. The machining swarf detection apparatus according to claim 5, wherein
the movable element is at least one of an in-machine robot, a tool post, a tool spindle, a workpiece table, and a tailstock, placed in the machining chamber.

7. A machine tool comprising the machining swarf detection apparatus according to claim 1.

8. The machine tool according to claim 7, further comprising:
a control device that controls driving of the machine tool; and
a cleaning mechanism that cleans the inside of the machining chamber by removing the machining swarf; wherein
the control device determines a location of cleaning by the cleaning mechanism according to a result of detection by the machining swarf detection apparatus.

9. The machine tool according to claim 8, wherein
the control device causes execution of the detection of the machining swarf by the machining swarf detection apparatus and the cleaning by the cleaning mechanism during a period in which machining of a workpiece is not executed.
